(19) United States
(12) Patent Application Publication
(10) Pub. No.: US 2010/0039429 A1
(43) Pub. Date: Feb. 18, 2010

(54) Apparatus and method for 3D animation rendering in portable terminal

(75) Inventor: Seung-Jae Han, Hwaseong-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/583,048

(22) Filed: Aug. 13, 2009

(30) Foreign Application Priority Data
Aug. 13, 2008 (KR) 10-2008-0079241

(51) Int. Cl. G06T 15/70

(52) U.S. Cl. 345/419; 345/473

(57) ABSTRACT

A portable terminal includes a three dimensional (3D) apparatus for rendering a 3D animation. In the method, one or more animation data for a 3D animation are generated when initializing an application program for execution of the 3D animation. An animation index is determined in consideration of the animation lapse time for the 3D animation when executing the 3D animation. The animation data corresponding to the animation index is selected among the generated animation data to perform a rendering operation.

### CROSS-REFERENCE TO RELATED APPLICATION(S) AND CLAIM OF PRIORITY

The present application is related to and claims priority under 35 U.S.C. § 119 to an application filed in the Korean Intellectual Property Office on Aug. 13, 2008 and assigned Serial No. 10-2008-0079241, the contents of which are incorporated herein by reference.

### TECHNICAL FIELD OF THE INVENTION

The present invention relates generally to an apparatus and method for displaying a three-dimensional (3D) image in a portable terminal, and in particular, to an apparatus and method for rendering a 3D animation in a portable terminal.

### BACKGROUND OF THE INVENTION

A portable terminal can display not only a two-dimensional (2D) image but also a 3D image and a 3D animation by using a 3D acceleration chip. Herein, the 3D acceleration chip displays a 3D image or animation on a display unit of the portable terminal by rendering 3D object data including the length, height and volume of the 3D image or animation. To this end, the portable terminal includes a 3D animation rendering apparatus as illustrated in FIG. 1.

FIG. 1 illustrates a block diagram of a conventional apparatus for rendering a 3D animation in a portable terminal.

Referring to FIG. 1, a 3D animation rendering apparatus 100 of a portable terminal includes an animation operating unit 110, a data transmitting unit 120, and a 3D rendering unit 130.

The animation operating unit 110 uses a quaternion to generate 3D object data including the length, height and volume of a 3D image.

The data transmitting unit 120 transmits the 3D object data, generated by the animation operating unit 110, to a storage unit of the 3D rendering unit 130. That is, the data transmitting unit 120 is a data bus located between the animation operating unit 110 and the 3D rendering unit 130.

The 3D rendering unit 130 renders and displays the 3D object data, received through the data transmitting unit 120, on a display unit.

When the above 3D animation rendering apparatus 100 is used to display a 3D animation, the animation operating unit 110, the data transmitting unit 120, and the 3D rendering unit 130 operate in real time. That is, while the 3D rendering unit 130 is rendering a 3D animation, the animation operating unit 110 generates 3D object data and transmits the 3D object data through the data transmitting unit 120 to the storage unit of the 3D rendering unit 130.

However, if the animation operating unit may have a low processing speed and the data transmitting unit may have a small bandwidth, the animation operating unit and the data transmitting unit may be unable to generate and transmit 3D object data in real time while the 3D rendering unit is rendering a 3D animation.

### SUMMARY OF THE INVENTION

To address the above-discussed deficiencies of the prior art, it is a primary aspect of the present invention is to address at least the above mentioned problems and/or disadvantages and to provide at least the advantages described below. Accordingly, an aspect of the present invention is to provide an apparatus and method for rendering a 3D animation in a portable terminal.

Another object of the present invention is to provide an apparatus and method for reducing a generation delay of 3D object data used to render a 3D animation in a portable terminal.

Another object of the present invention is to provide an apparatus and method for reducing a transmission delay of 3D object data used to render a 3D animation in a portable terminal.

According to an aspect of the present invention, a method for rendering a 3D animation in a portable terminal includes: generating one or more animation data for a 3D animation when initializing an application program for execution of the 3D animation; determining an animation index in consideration of the animation lapse time for the 3D animation when executing the 3D animation; and selecting and rendering the animation data corresponding to the animation index among the generated animation data.

According to another aspect of the present invention, an apparatus for rendering a 3D animation in a portable terminal includes: an animation preprocessing unit generating one or more animation data for a 3D animation when initializing an application program for execution of the 3D animation; an animation engine unit determining an animation index in consideration of the animation lapse time for the 3D animation; a rendering unit selecting and rendering the animation data corresponding to the animation index among the animation data generated by the animation preprocessing unit; and a display unit displaying the rendered 3D animation.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a conventional apparatus for rendering a 3D animation in a portable terminal;

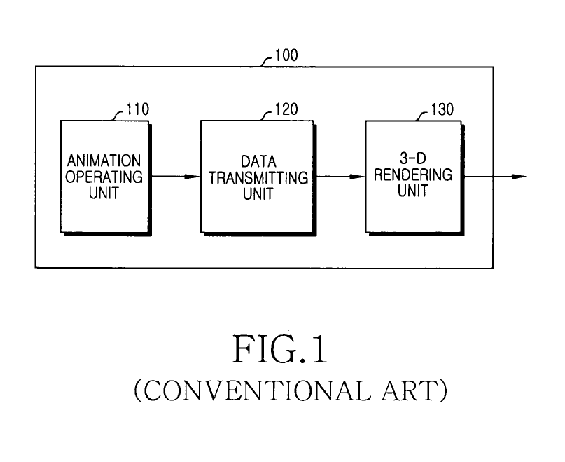

FIG. 2 illustrates a block diagram of an apparatus for rendering a 3D animation in a portable terminal according to an embodiment of the present invention;

FIG. 3 illustrates a flow chart for a process for generating 3D object data for a 3D animation in a portable terminal according to an embodiment of the present invention; and

FIG. 4 illustrates a flow chart for a process for rendering a 3D animation in a portable terminal according to an embodiment of the present invention.

### DETAILED DESCRIPTION OF THE INVENTION

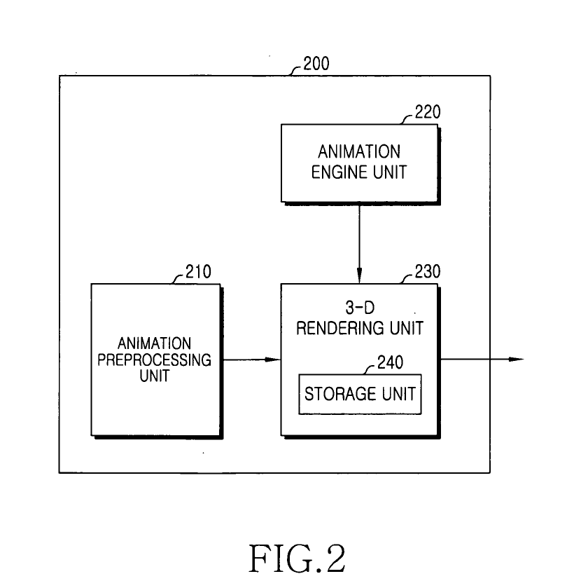

FIGS. 2 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides a technique for increasing the rendering performance for a 3D animation in a portable terminal. Specifically, the present invention provides a scheme for reducing a generation/transmission delay of 3D object data to prevent a degradation in the rendering performance for a 3D animation in a portable terminal. Herein, the rendering is a process for generating a 3D image in consideration of a shadow, a color tone and a density that depend on external information such as the shape, location and illumination of a 2D image.

In order to reduce a generation/transmission delay of 3D object data, the portable terminal generates 3D object data for a 3D animation when initializing an application program for the 3D animation. Herein, the 3D object data include the length, height and volume of a 3D image.

Accordingly, as illustrated in FIG. 2, the portable terminal includes an animation preprocessing unit for generating 3D object data for a 3D animation when initializing an application program for the 3D animation.

FIG. 2 illustrates a block diagram of an apparatus for rendering a 3D animation in a portable terminal according to an embodiment of the present invention.

Referring to FIG. 2, a 3D animation rendering apparatus 200 of the portable terminal includes an animation preprocessing unit 210, an animation engine unit 220, and a 3D rendering unit 230.

When initializing a 3D animation execution program, the animation preprocessing unit 210 pre-generates 3D object data for the 3D animation and stores the 3D object data in a storage unit 240 of the 3D rendering unit 230. Herein, the animation preprocessing unit 210 generates animation frames according to the animation repetition time and the maximum number of frames per second for a 3D animation. For example, if a 3D animation is repeated at intervals of 2 seconds and a maximum of 10 frames are included per second, the animation preprocessing unit 210 generates 20 animation frames at intervals of 0.1 second.

The animation engine unit 220 determines an animation index for selecting the frame according to an animation lapse time among the frames stored in the storage unit 240.

The 3D rendering unit 230 renders and displays the frame, which corresponds to the animation index received from the animation engine unit 220 among the frames stored in the storage unit 240, on a display unit of the portable terminal.

Hereinafter, a description will be given of a method for the animation preprocessing unit 210 to pre-generate 3D object data for a 3D animation when initializing the 3D animation execution program.

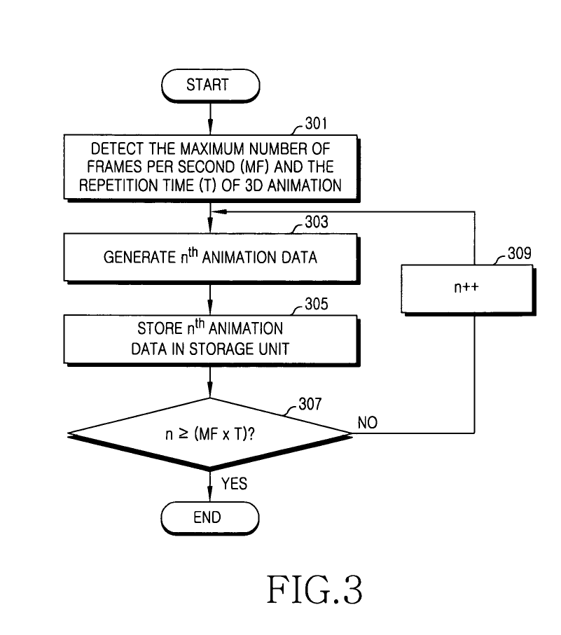

FIG. 3 illustrates a flow chart for a process for generating 3D object data for a 3D animation in a portable terminal according to an embodiment of the present invention.

Referring to FIG. 3, in step 301, the animation preprocessing unit 210 detects the animation repetition time (T) and the maximum number of frames per second (MF) for a 3D animation when initializing the 3D animation execution program.

In step 303, the animation preprocessing unit 210 generates the n^{th} animation data in order to execute a 3D animation at intervals of 1/MF. Herein, the n^{th} animation data are 3D object data for the n^{th} frame and the n has an initial value of ‘1’.

In step 305, the animation preprocessing unit 210 stores the generated n^{th} animation data in the storage unit 240 of the 3D rendering unit 230.

In step 307, the animation preprocessing unit 210 determines whether all the animation data for execution of a 3D animation are generated. That is, the animation preprocessing unit 210 compares the total number (MF×T) of animation execution frames and the index (n) of a frame for the animation data generated in step 303.

If all the animation data for execution of a 3D animation are not generated (n<(MF×T)) (in step 307), the animation preprocessing unit 210 proceeds to step 309. In step 309, the animation preprocessing unit 210 increases the index (n) of the animation data by one level (n++).

Thereafter, the animation preprocessing unit 210 returns to step 303. In step 303, the animation preprocessing unit 210 generates animation data corresponding to the increased animation data index (n). That is, the animation preprocessing unit 210 generates 3D object data for the n^{th} frame increased by one level.

If all the animation data for execution of a 3D animation are generated (n>(MF×T)) (in step 307), the animation preprocessing unit 210 ends the process of the present invention.

Hereinafter, a description will be given of a method for rendering a 3D animation by using the animation data that are pre-generated by the animation preprocessing unit 210 when initializing the 3D animation execution program.

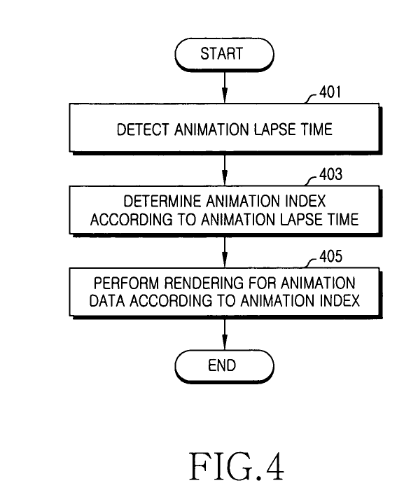

FIG. 4 illustrates a flow chart illustrating a process for rendering a 3D animation in a portable terminal according to an embodiment of the present invention.

Referring to FIG. 4, in step 401, the 3D animation rendering apparatus 200 detects an animation lapse time from the start of an animation.

In step 403, the 3D animation rendering apparatus 200 determines an animation index for selecting animation data according to the animation lapse time. Herein, the animation engine unit 220 of the 3D animation rendering apparatus 200 determines the animation index by rounding up the product of the animation lapse time (t) and the maximum number of frames per second (MF) for a 3D animation. For example, if the maximum number of frames per second is ten (10) and the animation lapse time is one tenth of a second (0.1 second), the animation engine unit 220 determines the animation index at ‘1’ (=10×0.1). If the maximum number of frames per second is ten (10) and the animation lapse time is 0.72 seconds, the animation engine unit 220 determines the animation index at ‘7’ (=10×0.72). Herein, the animation data are 3D object data for a frame corresponding to the animation index.

In step 405, the 3D animation rendering apparatus 200 performs rendering by using the animation data corresponding to the animation index. For example, the 3D animation rendering apparatus 200 performs rendering by using 3D object data of the frame corresponding to the animation index among the frames stored in the storage unit 240.

Thereafter, the 3D animation rendering apparatus 200 ends the process of the present invention.

As described above, the present invention pre-generates the 3D object data when initializing the application program for a 3D animation in the portable terminal, thereby making it possible to reduce a generation/transmission delay of the 3D object data to render the 3D animation in real time.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for rendering a three-dimensional (3D) animation in a portable terminal, comprising:
generating at least one animation data for a 3D animation when initializing an application program for execution of the 3D animation;
determining an animation index in consideration of the animation lapse time for the 3D animation when executing the 3D animation; and
selecting and rendering the animation data corresponding to the animation index among the generated animation data.

2. The method of claim 1, wherein the animation data are 3D object data for each frame for execution of the 3D animation.

3. The method of claim 2, wherein the 3D object data include at least one of a length, height and volume of a 3D image.

4. The method of claim 1, wherein generating the animation data comprises:
detecting the animation repetition time and the maximum number of frames per second for the 3D animation when initializing the application program for execution of the 3D animation; and
generating at least one animation data satisfying the maximum number of frames per second for the animation repetition time.

5. The method of claim 1, further comprising: storing the generated animation data in a storage unit after generating the animation data.

6. The method of claim 5, wherein rendering the animation data comprises:
selecting the animation data corresponding to the animation index from the storage unit; and
rendering the selected animation data.

7. The method of claim 1, wherein determining the animation index comprises determining the animation index by rounding up the product of the animation lapse time and the maximum number of frames per second for the 3D animation.

8. An apparatus for rendering a three-dimensional (3D) animation in a portable terminal, the apparatus comprising:
an animation preprocessing unit generating at least one animation data for a 3D animation when initializing an application program for execution of the 3D animation;
an animation engine unit determining an animation index in consideration of the animation lapse time for the 3D animation;
a rendering unit selecting and rendering the animation data corresponding to the animation index among the animation data generated by the animation preprocessing unit; and
a display unit configured to display the rendered 3D animation.

9. The apparatus of claim 8, wherein the animation preprocessing unit generates the animation data that is 3D object data for each frame for execution of the 3D animation.

10. The apparatus of claim 9, wherein the animation preprocessing unit generates the 3D object data including at least one of a length, height and volume of a 3D image.

11. The apparatus of claim 8, wherein the animation preprocessing unit generates at least one animation data satisfying the maximum number of frames per second for the animation repetition time of the 3D animation when initializing the application program for execution of the 3D animation.

12. The apparatus of claim 8, wherein the animation engine unit determines the animation index by rounding up the product of the animation lapse time and the maximum number of frames per second for the 3D animation.

13. The apparatus of claim 8, further comprising a storage unit configured to store the animation data generated by the animation preprocessing unit.

14. The apparatus of claim 13, wherein the animation preprocessing unit selects the animation data corresponding to the animation index from the storage unit to render the animation data.

15. A portable terminal capable of rendering a three-dimensional (3D) animation, the portable terminal comprising:
a 3D rendering apparatus, the 3D rendering apparatus comprising:
an animation preprocessing unit generating at least one animation data for a 3D animation when initializing an application program for execution of the 3D animation;
an animation engine unit determining an animation index in consideration of the animation lapse time for the 3D animation; and
a rendering unit selecting and rendering the animation data corresponding to the animation index among the animation data generated by the animation preprocessing unit; and
a display unit configured to display the rendered 3D animation.

16. The terminal of claim 15, wherein the animation preprocessing unit generates the animation data that is 3D object data for each frame for execution of the 3D animation.

17. The terminal of claim 16, wherein the animation preprocessing unit generates the 3D object data including at least one of a length, height and volume of a 3D image.

18. The terminal of claim 15, wherein the animation preprocessing unit generates at least one animation data satisfying the maximum number of frames per second for the animation repetition time of the 3D animation when initializing the application program for execution of the 3D animation.

19. The terminal of claim 15, wherein the animation engine unit determines the animation index by rounding up the product of the animation lapse time and the maximum number of frames per second for the 3D animation.

20. The terminal of claim 15, further comprising a storage unit configured to store the animation data generated by the animation preprocessing unit and wherein the animation preprocessing unit selects the animation data corresponding to the animation index from the storage unit to render the animation data.
